(19) United States
(12) Patent Application Publication
(10) Pub. No.: US 2021/0212542 A1
(43) Pub. Date: Jul. 15, 2021

(54) ROLLER BRUSH DEVICE AND CLEANING APPARATUS

(71) Applicants: JIANGSU MIDEA CLEANING APPLIANCES CO., LTD., SUZHOU (CN); MIDEA GROUP CO., LTD., FOSHAN (CN)

(72) Inventors: Bo HE, SUZHOU (CN); Xiaowei XU, SUZHOU (CN)

(21) Appl. No.: 16/758,382

(22) PCT Filed: Mar. 19, 2019
(86) PCT No.: PCT/CN2019/078667

§ 371 Date: Apr. 22, 2020

(30) Foreign Application Priority Data
Feb. 12, 2019 (CN) 201910111720.8

(51) Int. Cl. A47L 11/40; A47L 11/24; A47L 9/04

(52) U.S. Cl. CPC A47L 11/4041; A47L 11/24; A47L 9/0477; A47L 9/0411; A47L 11/4069

(57) ABSTRACT

The present disclosure provides a roller brush device and a cleaning apparatus. The roller brush device includes a roller brush and a mounting assembly. The roller brush is connected with the mounting assembly. The roller brush is rotatable relative to the mounting assembly, and the mounting assembly is able to drive the roller brush to move. One side of the mounting assembly defines an avoidance notch, and the roller brush is exposed at the avoidance notch.

### CROSS-REFERENCES TO RELATED APPLICATIONS

The present disclosure is a national phase application of International Application No. PCT/CN2019/078667, filed on Mar. 19, 2019, which claims priority to Chinese Patent Application No. 201910111720.8, filed on Feb. 12, 2019, the entire contents of which are incorporated herein by reference.

### FIELD

The present disclosure relates to the field of cleaning appliances, and more particularly to a roller brush device and a cleaning apparatus.

### BACKGROUND

Take the robot vacuum cleaner as an example, a roller brush of an existing robot vacuum cleaner is located at a bottom thereof. When the roller brush needs to be cleaned or replaced, the robot vacuum cleaner needs to be turned over and the bottom of the robot faces upwards, and then a bottom cover for the roller brush is opened and the roller brush is dismounted for cleaning. After the roller brush is cleaned or replaced, the roller brush is mounted to the robot vacuum cleaner, and then, the robot vacuum cleaner is turned over again. In the above-mentioned robot vacuum cleaner, the mounting and dismounting processes of the roller brush needs to turn the robot vacuum cleaner over for several times, which is not convenient for the mounting and dismounting of the roller brush.

### SUMMARY

In view of this, the present disclosure is intended to provide a roller brush device and a cleaning apparatus which facilitate mounting and dismounting.

To achieve the above objective, one aspect of embodiments of the present disclosure provides a roller brush device including a roller brush and a mounting assembly. The roller brush is connected with the mounting assembly, the roller brush is rotatable relative to the mounting assembly, and the mounting assembly is capable of driving the roller brush to move. A side of the mounting assembly defines an avoidance notch, and the roller brush is exposed at the avoidance notch.

Furthermore, the mounting assembly is provided with an accommodating cavity and an air outlet, the roller brush includes a roller brush shaft and a bristle, the roller brush shaft is arranged in the accommodating cavity, the avoidance notch is defined in a bottom side of the accommodating cavity, the air outlet is defined in a side of the accommodating cavity different from the bottom side, and an air flow in the accommodating cavity is capable of being discharged out of the accommodating cavity through the air outlet.

Furthermore, the mounting assembly includes a mounting rack and a shielding plate, an interior of the mounting rack is hollow, the shielding plate is sealablly arranged in the interior of the mounting rack to separate a space in the mounting rack into a first space and a second space isolated from each other, and the first space is formed into at least part of the accommodating cavity.

Furthermore, the mounting assembly includes a bottom cover and a mounting rack, the bottom cover is detachably connected with the mounting rack, the avoidance notch is defined in the bottom cover, the roller brush comprises a roller brush shaft and a bristle, and the roller brush shaft is mounted to the mounting rack and/or the bottom cover.

Furthermore, the bottom cover includes a bottom plate and a skirt portion extending from an edge of the bottom plate toward the mounting rack, the avoidance notch is defined in the bottom plate, two sides of the skirt portion along an axial direction of the roller brush defines a first mounting notch, two sides of the bottom of the mounting rack defines a second mounting notch, and the first mounting notch and the corresponding second mounting notch are enclosed together into a mounting hole, and two axial ends of the roller brush shaft rotatably pass through the mounting hole.

Furthermore, a bottom end face of the bottom cover away from the mounting rack is formed into an inclined face, the roller brush device also includes a roller supporting portion rotatably arranged to a lower side of the bottom end face of the bottom cover, at least part of a structure of the roller supporting portion is protruded from the bottom end face of the bottom cover, and a rotation center line of the roller supporting portion is parallel to a rotation center line of the roller brush.

Furthermore, the roller supporting portion is formed into a roller shaft.

Furthermore, the roller brush device includes a lifting portion connected with the mounting rack, and at least part of a structure of the lifting portion is exposed at a top side of the mounting rack.

Furthermore, the mounting rack is made of a transparent material.

Furthermore, the roller brush device includes a first driving connection portion configured to connect a power source, and the first driving connection portion is drivingly connected with at least one shaft end of the roller brush.

Another aspect of embodiments of the present disclosure provides a cleaning apparatus, which includes a main body portion and any one of the above roller brush devices. The main body portion defines a mounting cavity therein, a bottom side of the mounting cavity defines a first opening, and the roller brush is exposed at the first opening. A side of the mounting cavity different from the bottom side defines a second opening, and the roller brush device is capable of being mounted in or removed from the mounting cavity through the second opening.

Furthermore, the second opening is defined in a top side of the main body portion.

Furthermore, an inner wall of the mounting cavity is provided with a step face, the mounting assembly is provided with a flange structure, and the flange structure is supported on the step face.

Furthermore, the cleaning apparatus includes a second driving connection portion; the roller brush device includes a first driving connection portion, the first driving connection portion is drivingly connected with at least one shaft end of the roller brush, and the second driving connection portion and the first driving connection portion is capable of switching between a driving connection and a disconnection.

Furthermore, the second driving connection portion is capable of reciprocating along an axial direction of the roller brush, the second driving connection portion moves to a first preset position in a direction away from the first driving connection portion, the second driving connection portion is disconnected from the first driving connection portion; the second driving connection portion moves to a second preset position in a direction toward the first driving connection portion, and the second driving connection portion and the first driving connection portion are drivingly connected.

Furthermore, the first driving connection portion forms a plurality of first claws at a side thereof facing the second driving connection portion, the second driving connection portion forms a plurality of second claws at a side thereof facing the first driving connection portion, and the plurality of the second claws cooperates with the plurality of the first claws in an insertion way.

Furthermore, the cleaning apparatus is a robot vacuum cleaner.

The roller brush device according to embodiments of the present disclosure, by connecting the roller brush and the mounting assembly, when the roller brush needs to be dismounted, the whole roller brush device may be removed from a top or a side of the cleaning apparatus, or the whole roller brush device may be mounted into the cleaning apparatus from the top or the side of the cleaning apparatus, without turning over the cleaning apparatus, which is not only convenient for the user to dismount by himself, but also may avoid the scratches of the appearance of the cleaning apparatus caused by turning over the cleaning apparatus.

### BRIEF DESCRIPTION OF THE DRAWINGS

The attached drawings are used to provide a further understanding of the present disclosure and constitute a part of the description, which are used to explain the present disclosure with reference to the following embodiments, and are not construed as the limitation of the present disclosure. In which:

FIG. 1 is a schematic view of a cleaning apparatus according to an embodiment of the present disclosure;

FIG. 2 is a schematic view of another perspective of the cleaning apparatus illustrated in FIG. 1;

FIG. 3 is a partial exploded view of the cleaning apparatus illustrated in FIG. 1;

FIG. 4 is a schematic view of a roller brush device according to an embodiment of the present disclosure;

FIG. 5 is a schematic view of another perspective of the roller brush device illustrated in FIG. 4;

FIG. 6 is a schematic view of yet another perspective of the roller brush device illustrated in FIG. 4;

FIG. 7 is an exploded view of the roller brush device illustrated in FIG. 4;

FIG. 8 is a schematic view of a fitting structure of the roller brush device illustrated in FIG. 4 with a second driving connection portion, a conveyor belt and an electric motor of an embodiment; and

FIG. 9 is a schematic view of a second driving connection portion according to an embodiment of the present disclosure.

### REFERENCE NUMERALS

### Description of Reference Numerals

main body portion 10; mounting cavity 101; first opening 102; second opening 103; step face 104; roller brush device 20; roller brush 21; roller brush shaft 210; bristle 211; mounting rack 22; flange structure 221; first space 22a; second space 22b; second mounting notch 22c; shielding plate 23; bottom cover 24; bottom plate 241; skirt portion 242; first mounting notch 24a; avoidance notch 20a; air outlet 20b; accommodating cavity 20c; mounting hole 20d; lifting portion 25; first driving connection portion 27; first claw 271; roller supporting portion 28; second driving connection portion 31; second claw 311; electric motor 32; conveyor belt 33.

### DETAILED DESCRIPTION OF THE DISCLOSURE

It should be noted that embodiments of the present disclosure may be combined with each other. It should be understood that the embodiments described herein are only used for explaining the present disclosure, but should not be construed to limit the present disclosure.

In the description of the present disclosure, it should be understood that, terms such as “top,” “bottom,” “lateral,” indicate the orientation or position relationship based on the orientation or position relationship illustrated in the FIG. 1 only for convenience of description or for simplifying description of the present disclosure, and do not indicate or imply that the device or element referred to must have a particular orientation or be constructed and operated in a specific orientation, and hence cannot be construed as a limitation to the present disclosure.

Place a cleaning apparatus on a surface of the cleaning medium, such as ground. A side close to the cleaning medium is “bottom”, and a side away from the cleaning medium is “top”.

An embodiment of the present disclosure provides a roller brush device 20. In order to simplify description, in the embodiment of the present disclosure, a roller brush device 20 applied to the cleaning apparatus is described as an example. In an embodiment, the cleaning apparatus is described as a robot vacuum cleaner for an example. It should be understood that the cleaning apparatus may be of other types. The roller brush device 20 according to embodiments of the present disclosure may also be used for other devices.

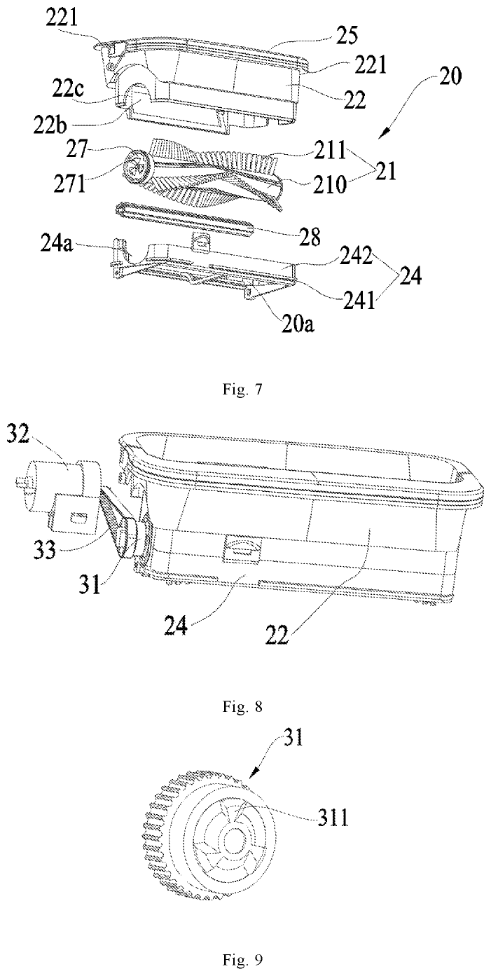

Referring to FIG. 7, the roller brush device 20 according to the embodiment of the present disclosure includes a roller brush 21 and a mounting assembly. The roller brush 21 is connected with the mounting assembly. The roller brush 21 is rotatable relative to the mounting assembly, and the mounting assembly may drive the roller brush 21 to move. An avoidance notch 20a is defined in a side of the mounting assembly, and the roller brush 21 is exposed at the avoidance notch 20a. The roller brush device 20 of the embodiment of the present disclosure may realize the convenient mounting and dismounting of the roller brush 21 by connecting the roller brush 21 with the mounting assembly. In an operation process, for example, when the roller brush 21 needs to be dismounted, the whole roller brush device 20 may be removed from a top or a side of the cleaning apparatus, or the whole roller brush device 20 may be mounted into the cleaning apparatus from the top or the side of the cleaning apparatus, without turning over the cleaning apparatus, which is not only convenient for the user to dismount by himself, but also may avoid the scratches of the appearance of the cleaning apparatus caused by turning over the cleaning apparatus.

Referring to FIG. 7 again, the roller brush 21 refers to a structure that may rotate on its own and clean a cleaning medium such as ground. In the embodiment of the present disclosure, the roller brush 21 includes a roller brush shaft 210 and a bristle 211 connected with the roller brush shaft 210. The connection method between the bristle 211 and the roller brush shaft 210 is not limited, and the shape and material of the bristle is not limited, for example, which may be a brush strip, fluff, and the like.

The embodiment of the present disclosure is described with an example that the roller brush device 20 may be dismounted from the top of the cleaning apparatus.

The mounting assembly may provide a mounting position and support for the roller brush 21, which facilitates the mounting and dismounting of the roller brush 21. Referring to FIG. 6, in one embodiment of the present disclosure, the mounting assembly is provided with an accommodating cavity 20c and an air outlet 20b, the roller brush shaft 210 is accommodated in the accommodating cavity 20c, the avoidance notch 20a is defined in a bottom side of the accommodating cavity 20c, i.e. a side facing the cleaning medium, and the bristle 211 may extend out of the avoidance notch 20a to contact the cleaning medium. The air outlet 20b is defined in a side of the accommodating cavity 20c different from the bottom side. That is, the air outlet 20b is not arranged in the bottom side but in a top side or a lateral side of the accommodating cavity 20c. An air flow in the accommodating cavity 20c is discharged out of the accommodating cavity 20c through the air outlet 20b, and that is, the air outlet 20b is communicated with the accommodating cavity 20c. A negative pressure may be formed in the accommodating cavity 20c to facilitate sucking dust, hair, and the like, and the air flow mixed with dust, hair and other debris flows to a dust collection structure (not illustrated in the drawings) of the cleaning apparatus through the air outlet 20b.

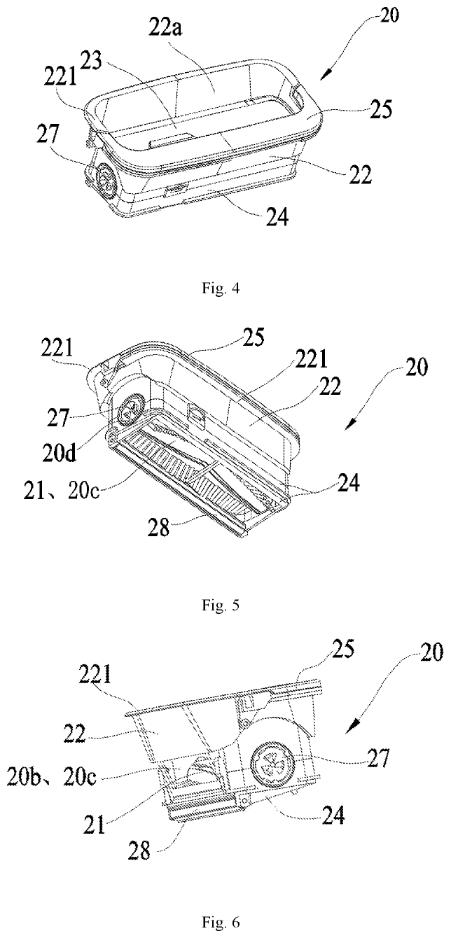

In one embodiment of the present disclosure, referring to FIG. 4, the mounting assembly includes a mounting rack 22 and a shielding plate 23. An interior of the mounting rack 22 is hollow, and the mounting rack 22 has a generally hollow cylinder shape. A top and a bottom of the mounting rack 22 are formed into an open structure. The shielding plate 23 is sealablly arranged in the interior of the mounting rack 22, and that is, a periphery of the shielding plate 23 sealablly abuts against an inner wall of the mounting rack 22, to separate a space in the mounting rack 22 into a first space 22a and a second space 22b which are isolated from each other. The first space 22a is formed into at least part of the accommodating cavity 20c, and the air outlet 20b is defined in a lateral side of the accommodating cavity 20c and communicated with the first space 22a, and that is, the first space 22a may be or may be part of the accommodating cavity 20c. The spaces of the bottom and the top of the mounting rack 22 may be separated by the shielding plate 23, and an air flow in the first space 22a is discharged along the air outlet 20b rather than is discharged from other positions of the mounting rack 22, to better form a negative pressure and improve the cleaning effect. It should be understood that, in order to facilitate the user to observe the operating condition of the roller brush 21 intuitively, the shielding plate 23 may be made of a transparent material.

In order to facilitate the user to lift the roller brush device 20, in one embodiment of the present disclosure, referring to FIG. 4 again, the mounting assembly also includes a lifting portion 25. The lifting portion 25 is connected with the mounting rack 22, and at least part of the lifting portion 25 is exposed at a top side of the mounting rack 22. In an operation process, the user may grab the lifting portion 25 to lift the roller brush device 20 out of the cleaning apparatus. A structure of the lifting portion 25 is not limited, for example, which may be a protruding structure protruded from the second space 22b of the mounting rack 22 or may be a rotatable handle. In the embodiment of the present disclosure, the lifting portion 25 is formed into the rotatable handle. When the roller brush device 20 is mounted in the cleaning apparatus, the handle is fitted with the top of the mounting rack 22. When the roller brush device 20 needs to be removed, the above handle may be lifted after being rotated by a certain angle.

In one embodiment of the present disclosure, referring to FIG. 5, a flange structure 221 is formed on the top of the mounting rack 22, and the roller brush device 20 may be stably supported in the cleaning apparatus by the flange structure 221. It should be understood that, the above handle may be fitted with a top surface of the flange structure 221 in order to compact the structure.

In order to facilitate the mounting of the roller brush 21 and prevent large-sized objects from being sucked into the accommodating cavity 20c, in one embodiment of the present disclosure, referring to FIG. 7, the mounting assembly includes a bottom cover 24, the bottom cover 24 is detachably connected with the mounting rack 22, and the avoidance notch 20a is defined in the bottom cover 24. That is, the bottom cover 24 is arranged to a bottom side of the mounting rack 22. In the present embodiment, the bottom cover 24, the mounting rack 22 and the shielding plate 23 are enclosed together into the accommodating cavity 20c, and that is, in the present embodiment, the first space 22a serves as part of the accommodating cavity 20c. When the roller brush 21 needs to be dismounted, the bottom cover 24 may be separated from the mounting rack 22 after the roller brush device 20 is removed from the cleaning apparatus, and then the roller brush 21 may be removed.

Referring to FIG. 6, a bottom end face of the bottom cover 24 away from the mounting rack 22 is formed into an inclined face. The roller brush device also includes a roller supporting portion 28, the roller supporting portion 28 is rotatably arranged to a lower side of the bottom end face of the bottom cover 24, and at least part of the structure of the roller supporting portion 28 is protruded from the bottom end face of the bottom cover 24, and the roller supporting portion 28 may be rollingly supported on a surface of the cleaning medium. A rotation center line of the roller supporting portion 28 is parallel to that of the roller brush 21. By setting the bottom end face of the bottom cover 24 as the inclined face, the roller supporting portion 28 is supported on the surface of the cleaning medium during the operation of the cleaning apparatus, and the other side of the bottom cover 24 opposite to the side where the roller supporting portion 28 is located is separated from the surface of the cleaning medium, and a certain gap exists between the bottom end face of the bottom cover 24 and the surface of the cleaning medium, facilitating surrounding air to enter the accommodating cavity 20c under the action of the negative pressure in the accommodating cavity 20c.

Referring to FIG. 6 again, in the embodiment of the present disclosure, the roller supporting portion 28 is formed into a roller shaft, which plays a rolling support role as well as maintains a good contact with the surface of the cleaning medium, to improve the negative pressure effect in the accommodating cavity 20c.

The bottom cover 24 may protect the roller brush 21 and prevent large-size objects from being sucked into the accommodating cavity 20c. The bottom cover 24 may also facilitate the mounting of the roller brush 21. Specifically, the roller brush 21 is mounted to the mounting rack 22 and/or the bottom cover 24. That is, the roller brush 21 may only be mounted to the mounting rack 22; or may also only be mounted to the bottom cover 24, or may also be mounted at a junction of the mounting rack 22 and the bottom cover 24, which is connected with both of the mounting rack 22 and the bottom cover 24.

In the embodiment of the present disclosure, referring to FIGS. 4 to 6, the roller brush 21 is mounted at the junction of the mounting rack 22 and the bottom cover 24.

In the embodiment of the present disclosure, referring to FIG. 7, the bottom cover 24 includes a bottom plate 241 and a skirt portion 242 extending from an edge of the bottom plate 241 toward the mounting rack 22. The avoidance notch 20a is defined in the bottom plate 241. A top surface of the skirt portion 242 is fittingly contacted with the bottom surface of the mounting rack 22, and there is no air leakage at a junction of the skirt portion 242 and the mounting rack 22. The connection method of the skirt portion 242 and the mounting rack 22 is not limited, as long as a detachable connection may be realized.

Referring to FIG. 7, two sides of the skirt portion 242 along the axial direction of the roller brush 21 define first mounting notches 24a, two sides of the bottom of the mounting rack 22 defines second mounting notches 22c, and the first mounting notch 24a and the corresponding second mounting notch 22c are enclosed together into a mounting hole 20d (referring to FIG. 5). That is, one first mounting notch 24a corresponds to one second mounting notch 22c, and two mounting holes 20 are defined in total. Two axial ends of the roller brush shaft 210 rotatably pass through the corresponding mounting holes 20d. In such a way, when the bottom cover 24 is dismounted from the mounting rack 22, the roller brush 21 may be removed from the mounting assembly.

In order to facilitate driving connection of the roller brush 21, in one embodiment of the present disclosure, referring to FIG. 7, the roller brush device 20 includes a first driving connection portion 27, and the first driving connection portion 27 is drivingly connected with at least one shaft end of the roller brush 21. Exemplarily, an end face of the first driving connection portion 27 away from the mounting rack 22 forms a plurality of first claws 271. The power mechanism may drive the first driving connection portion 27 to rotate, and then drive the roller brush 21 to rotate synchronously by the cooperation of the first claw 271 and the power mechanism.

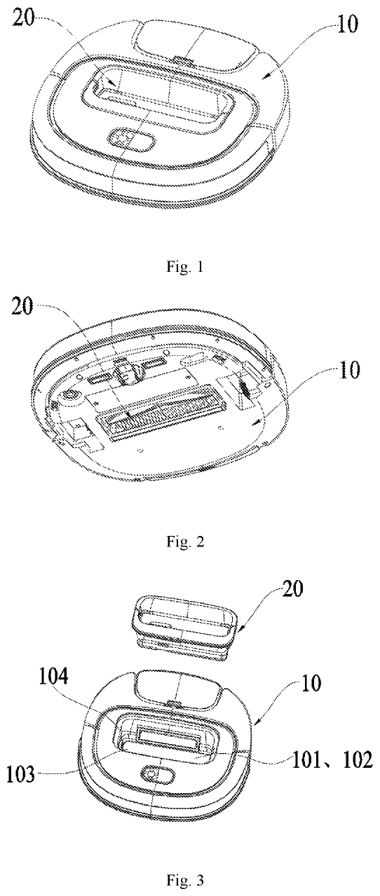

Referring to FIGS. 1-3, another aspect of embodiments of the present disclosure provides a cleaning apparatus, which includes a main body portion 10 and any one of the above roller brush devices 20.

Referring to FIG. 3, a mounting cavity 101 is defined in the main body portion 10, a first opening 102 is defined in a bottom side of the mounting cavity 101, and the roller brush 21 is exposed at the first opening 102. A second opening 103 is defined in a side of the mounting cavity 101 different from the bottom side, and that is, the second opening 103 will not be arranged in the bottom side. For example, the second opening 103 may be arranged in a top side or the lateral side of the mounting cavity 101, and the roller brush device 20 may be mounted in or removed from the mounting cavity 101 through the second opening 103. In an operation process, when the roller brush 21 is dismounted, the whole roller brush device 20 only needs to be removed from the mounting cavity 101 via the second opening 103 without turning over the cleaning apparatus; when the roller brush 21 needs to be mounted, the whole roller brush device 20 only needs to be mounted into the mounting cavity 101 through the second opening 103, which is convenient for the mounting and dismounting, and the top surface of the main body portion 10 can be prevented from scratches due to turning upside down.

In one embodiment of the present disclosure, the second opening 103 is located in a top of the main body portion 10, to facilitate the user to directly remove the roller brush device 20; and a top space is large enough to mount or remove the roller brush device 20, to more conveniently mount and dismount the roller brush device 20.

In order to facilitate positioning the roller brush device 20, referring to FIG. 3, a step face 104 is formed at an inner wall of the mounting cavity 101, and the step face 104 faces the top of the main body portion 10. Correspondingly, a flange structure 221 is formed on the mounting assembly. In the embodiment of the present disclosure, the flange structure 221 is formed on the top of the mounting rack 22, the roller brush device 20 is mounted into the mounting cavity 101 from the second opening 103, the flange structure 221 abuts against the step face 104, and the step face 104 may support the roller brush device 20.

Referring to FIGS. 8 and 9, the cleaning apparatus also includes a second driving connection portion 31, and the second driving connection portion 31 and the first driving connection portion 27 may switch between a driving connection and a disconnection. For example, when the roller brush device 20 needs to be removed from the mounting cavity 101, the second driving connection portion 31 and the first driving connection portion 27 are disconnected, and when the roller brush device 20 is mounted in the mounting cavity 101 and does not need to be removed, the second driving connection portion 31 and the first driving connection portion 27 are drivingly connected.

The second driving connection portion 31 may reciprocate along an axial direction of the roller brush 21. Specifically, when the roller brush device 20 needs to be removed from the mounting cavity 101, the second driving connection portion 31 moves to a first preset position in a direction away from the first driving connection portion 27 and the second driving connection portion 31 is disconnected from the first driving connection portion 27. When the roller brush device 20 is mounted in the mounting cavity 101 and does not need to be removed, the second driving connection portion 31 moves to a second preset position in a direction toward the first driving connection portion 27, and the second driving connection portion 31 and the first driving connection portion 27 are realized to be drivingly connected.

It should be noted that the above first preset position meets the following requirements: the second driving connection portion 31 is in the first preset position, and the second driving connection portion 31 does not interfere with the first driving connection portion 27. The second preset position meets the following requirements: the second driving connection portion 31 is in the second preset position, and the second driving connection portion 31 may be drivingly connected with the first driving connection portion 27 to drive the first driving connection portion 27 to rotate.

There are various ways to implement movement of the second driving connection portion 31 moves along the direction of the roller brush shaft 210. Exemplarily, the cleaning apparatus includes a restoring member (not illustrated in the drawings) and a transmission control mechanism (not illustrated in the drawings). The restoring member applies a driving force to the second driving connection portion 31 toward the first driving connection portion 27, and the restoring member may be a spring, a rubber band or a magnet. The transmission control mechanism applies a force opposite to the above driving force to the restoring member and/or the second driving connection portion 31 when the roller brush device 20 needs to be removed. For example, the transmission mechanism may include a button arranged on an outer surface of the cleaning apparatus, when the roller brush device 20 needs to be removed, the user presses the button, the force applied by the transmission mechanism overcomes the driving force of the above restoring member, forcing the second driving connection portion 31 to move in a direction away from the first driving connection portion 27, to make room for a clearance space, preventing an interference with the first driving connection portion 27 during a removal process. In a case that the roller brush device 20 doesn't need to be removed, the transmission control mechanism does not work, and the second driving connection portion 27 maintains to be drivingly connected with the first driving connection portion 27 under an action of the restoring member.

In the embodiment of the present disclosure, referring to FIG. 7, the first driving connection portion 27 is generally in disc shape and forms a plurality of first claws 271 extending toward the second driving connection portion 31. Referring to FIG. 9, the second driving connection portion 31 forms a plurality of second claws 311 extending toward the first driving connection portion 27. The first claw 271 and the second claw 311 are staggered and inserted with each other, and when the second driving connection portion 31 rotates, the second claws 311 drive the first claws 271 to rotate, realizing that the first driving connection portion 27 drives the roller brush 21 to rotate.

Referring to FIG. 8, the cleaning apparatus also includes an electric motor 32 and a conveyor belt 33, and the conveyor belt 33 is connected between the electric motor 32 and the second driving connection portion 31. The conveyor belt 33 may be structures such as a belt, a chain or the like. The conveyor belt 33 has a certain length to have certain flexibility, and may allow the second driving connection portion 31 to move axially.

1. A roller brush device, comprising:
a roller brush; and
a mounting assembly connected with the roller brush, the roller brush being rotatable relative to the mounting assembly, the mounting assembly being capable of driving the roller brush to move, a side of the mounting assembly defining an avoidance notch, and the roller brush being exposed at the avoidance notch.

2. The roller brush device according to claim 1, wherein the mounting assembly is provided with an accommodating cavity and an air outlet, the roller brush comprises a roller brush shaft and a bristle, the roller brush shaft is arranged in the accommodating cavity, the avoidance notch is defined in a bottom side of the accommodating cavity; the air outlet is defined in a side of the accommodating cavity different from the bottom side, and an air flow in the accommodating cavity is capable of being discharged out of the accommodating cavity through the air outlet.

3. The roller brush device according to claim 2, wherein the mounting assembly comprises a mounting rack and a shielding plate, an interior of the mounting rack is hollow, the shielding plate is sealably arranged in the interior of the mounting rack to separate a space in the mounting rack into a first space and a second space isolated from each other, and the first space is formed into at least part of the accommodating cavity.

4. The roller brush device according to claim 1, wherein the mounting assembly comprises a bottom cover and a mounting rack, the bottom cover is detachably connected with the mounting rack, the avoidance notch is defined in the bottom cover, the roller brush comprises a roller brush shaft and a bristle, and the roller brush shaft is mounted to the mounting rack and/or the bottom cover.

5. The roller brush device according to claim 4, wherein the bottom cover comprises a bottom plate and a skirt portion extending from an edge of the bottom plate toward the mounting rack, the avoidance notch is defined in the bottom plate, two sides of the skirt portion along an axial direction of the roller brush define a first mounting notch, two sides of the bottom of the mounting rack define a second mounting notch, and the first mounting notch and the corresponding second mounting notch are enclosed together into a mounting hole, and two axial ends of the roller brush shaft rotatably pass through the mounting hole.

6. The roller brush device according to claim 4, wherein a bottom end face of the bottom cover away from the mounting rack is formed into an inclined face, the roller brush device further comprises a roller supporting portion rotatably arranged to a lower side of the bottom end face of the bottom cover, at least part of a structure of the roller supporting portion is protruded from the bottom end face of the bottom cover, and a rotation center line of the roller supporting portion is parallel to a rotation center line of the roller brush.

7. The roller brush device according to claim 6, wherein the roller supporting portion is formed into a roller shaft.

8. The roller brush device according to claim 3, further comprising a lifting portion connected with the mounting rack, and at least part of a structure of the lifting portion being exposed at a top side of the mounting rack.

9. The roller brush device according claim 3, wherein the mounting rack is made of a transparent material.

10. The roller brush device according to claim 1, comprising: a first driving connection portion drivingly connected with at least one shaft end of the roller brush.

11. A cleaning apparatus, comprising: a main body portion and a roller brush devices according to claim 1, wherein the main body portion defines a mounting cavity thererin, a bottom side of the mounting cavity defines a first opening, the roller brush is exposed at the first opening, a side of the mounting cavity different from the bottom side defines a second opening, and the roller brush device is capable of being mounted in or removed from the mounting cavity through the second opening.

12. The cleaning apparatus according to claim 11, wherein the second opening is defined in a top side of the main body portion.

13. The cleaning apparatus according to claim 11, wherein an inner wall of the mounting cavity is provided with a step face, the mounting assembly is provided with a flange structure, and the flange structure is supported on the step face.

14. The cleaning apparatus according to claim 11, comprising a second driving connection portion, the roller brush device comprising a first driving connection portion, the first driving connection portion being drivingly connected with at least one shaft end of the roller brush, and the second driving connection portion and the first driving connection portion being capable of switching between a driving connection and a disconnection.

15. The cleaning apparatus according to claim 14, wherein the second driving connection portion is capable of reciprocating along an axial direction of the roller brush, the second driving connection portion moves to a first preset position in a direction away from the first driving connection portion, the second driving connection portion is disconnected from the first driving connection portion; the second driving connection portion moves to a second preset position in a direction toward the first driving connection portion, and the second driving connection portion and the first driving connection portion are drivingly connected.

16. The cleaning apparatus according to claim 14, wherein the first driving connection portion forms a plurality of first claws at a side thereof facing the second driving connection portion, the second driving connection portion forms a plurality of second claws at a side thereof facing the first driving connection portion, and the plurality of the second claws cooperates with a plurality of the first claws in an insertion way.

17. The cleaning apparatus according to claim 11, wherein the cleaning apparatus is a robot vacuum cleaner.
